(19) United States
(12) Patent Application Publication
(10) Pub. No.: US 2007/0223463 A1
(43) Pub. Date: Sep. 27, 2007

(54) METHOD OF IDENTITY-BASED INTELLIGENT ROUTING, STORAGE, AND INTEGRATION OF MULTIPLE MODES OF COMMUNICATION AMONG MULTIPLE DEVICES LINKED THROUGH A CLIENT/SERVER INTERACTION

(76) Inventors: Mark Brauer Weinberger, Philadelphia, PA (US); Ian Gervase Goldstein, Xenia, OH (US)

Correspondence Address: XEPIA INC., 729 GLENGARY ROAD, PHILADELPHIA, PA, 19118, US

(21) Appl. No.: 11/687,668

(22) Filed: Mar. 18, 2007

Related U.S. Application Data
(60) Provisional application No. 60/784,902, filed on Mar. 23, 2006.

(51) Int. Cl. H04L 12/66

(52) U.S. Cl. 370/356

(57) ABSTRACT

An architecture for unifying communication networks and protocols via a network of centralized servers, using multiple processes to intelligently route messages among various devices. Through Application Programming Interfaces the server can connect to Internet-ready devices, cell phones, and land-line phones.

### CROSS-REFERENCE TO RELATED APPLICATIONS

This application claims the benefit of provisional application Ser. No. 60/784,902, filed Mar. 23, 2006, now abandoned, and entitled “METHOD OF IDENTITY-BASED INTELLIGENT ROUTING, STORAGE, AND INTEGRATION OF MULTIPLE MODES OF COMMUNICATION AMONG MULTIPLE DEVICES LINKED THROUGH A CLIENT/SERVER INTERACTION.”

### BACKGROUND OF THE INVENTION

1. Field of the Invention

The present invention relates generally to electronic communication and more specifically it relates to a method of storing and facilitating transmission of different modes of IP-based and cellular-based text and voice communication in addition to traditional Public Switched Telephone Network voice communication among end users via a centralized network of servers as directed by user-defined routing instructions.

2. Description of the Related Art

It can be appreciated that Internet-based communication, such as email and instant messaging, is widely used. Voice communication via the Public Switched Telephone Network as well as via cellular networks is also a fixture in the communications landscape.

The main problem with the existing communications system is that these modes of communication are incompatible and uncoordinated. Different types of communication are used for different purposes, and users have varying preferences for the format in which they would like to receive incoming messages depending upon where they are, what they are doing, or who is contacting them. Currently, real-time text communication has limited routing capabilities due to its peer-to-peer nature, and other forms of text communication such as email and SMS-based text messages have limited routing capabilities due to their lack of integration with each other as well as with real-time text messaging and other modes of communication. Different client applications are required for different types of communication such as email and instant messaging or voice messaging.

Another problem is that most electronic text communication is primarily peer-to-peer. As such, it is not designed for central storage and therefore cannot easily be accessed from multiple locations. In addition, contact lists on different devices and different applications are uncoordinated and cannot necessarily be accessed from multiple locations or easily changed across all devices.

While each of these individual communication processes may be suitable for their narrow intended function of transmitting data via a specified type of network or viewable by a specified type of software for a specified user experience, they are not suitable for providing a comprehensive identity-based unified communication system that processes and standardizes incoming and outgoing communications protocols via a centralized system for greater user control, empowerment, access, privacy, and ease of use.

In these respects, the unified communication system according to the present invention substantially departs from the conventional concepts and designs of the prior art, and in so doing provides a process primarily developed for the purpose of unifying existing incompatible modes of communication via centralized client/server architecture.

### SUMMARY OF THE INVENTION

In view of the foregoing disadvantages inherent in the known types of communication now present in the prior art, the present invention provides a framework wherein the same can be utilized for integrating these known types of communication into a unified system.

The general purpose of the present invention, which will be described subsequently in greater detail, is to provide a new communications infrastructure that has all of the advantages of the current distinct forms of communication mentioned heretofore and many novel features that result in a new method of routing and storing communication and information related to it which is not anticipated, rendered obvious, suggested, or even implied by any of the existing individual forms of communication, either alone or in any combination thereof.

To attain this, the present invention generally comprises a centralized network of servers running our proprietary server software with associated proprietary client software through which end-users access their accounts. A user's account on the server will specify their account identification for the third-party networks and services that the user wishes to unify. Through Application Programming Interfaces (APIs), the server will intercept communication from those third parties and direct them to the user's inbox on our server for storage while also routing it to the specific device the user desires based on their preferences. The user will then access this communication through the client software or will be notified of the incoming communication via a third-party network or service such as SMS or voice. The user will also initiate communication through our client software or a voice interface, which will then be stored and routed through our servers as appropriately specified. Our servers will further store contact and address book information, profile information, and routing preferences for each user. The client software will run on personal computers, personal digital assistants, cell phones, and Internet browsers.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of user-to-user communication and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Primarily, the present invention may unify multiple incompatible modes of communication into a single system that will overcome the shortcomings of the prior art devices.

The invention may provide a single inbox for all of the user's incoming communication from email, instant messaging networks, cell phone text messages, voice messages, and any other form of communication that may reasonably be incorporated into an IP-based system.

The invention may provide routing capabilities of incoming communication to any of the user's communication devices through on user-defined preferences based on location, sender identity, calendar or schedule information, urgency, and any other variable that may reasonably be used as a basis for communication routing.

The invention may provide a centrally stored contact list accessible from any of the user's communication devices, through which the user can specify different routing instructions for individual contacts or categories of contacts.

The invention may provide full communication functionality across third-party networks and services through a simplified client interface.

The invention may provide presence and availability functionality such that users can view each other's calendar and/or customized availability information on-demand based on user-defined privacy settings.

The invention may provide a method of instantaneously contacting multiple people through multiple devices via a single message.

The invention may provide centralized search functions for all archived messages and communication, regardless of the form in which they were received or sent.

The invention may convert text messages to voice and voice messages to text, enabling hybrid text-voice conversations or messages.

The invention may allow users to change contact or device information on our system without having to notify other users, as the new information will automatically be reflected in the server routing instructions.

The invention may provide calendaring functionality compatible with other calendaring programs and linked to routing preferences.

The invention may provide flexibility to users regarding how they access their accounts and messages via plug-ins, client software, a voice prompt system, or a third-party protocol.

The invention may provide centralized security and privacy settings that would apply to profile, accessibility, and routing information.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying diagrams, in which like reference characters designate the same or similar components throughout the several views, and wherein:

FIG. 1 is a diagram of the basic system infrastructure logic

FIG. 2 is a diagram of the detailed system infrastructure logic

FIG. 3 is a diagram of the detailed system infrastructure components

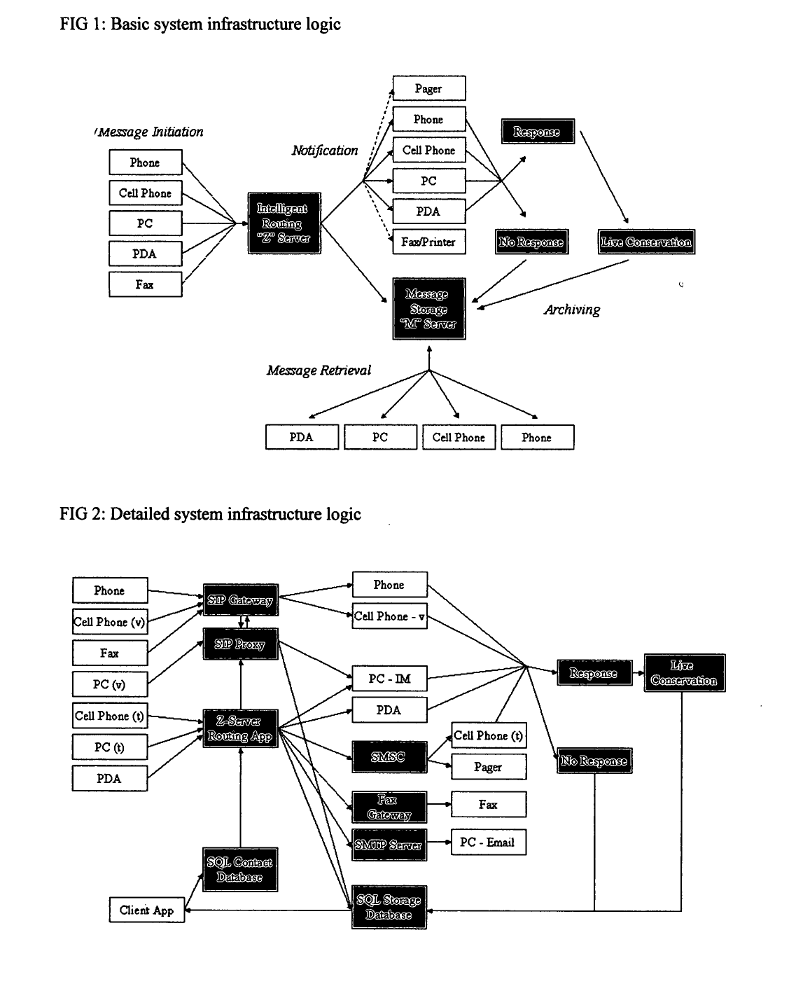

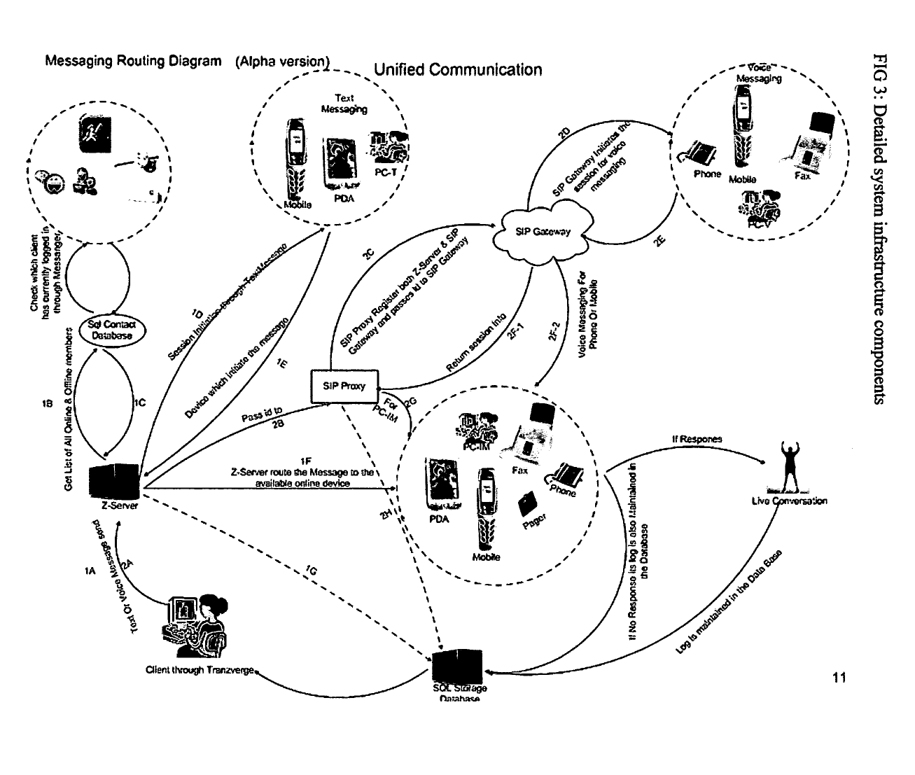

### DETAILED DESCRIPTION OF THE INVENTION

Turning now descriptively to the diagrams, in which similar reference characters denote similar elements throughout the several views, the attached figures illustrate a unified communication system, which comprises a server component that stores profile information and messages, a server component that connects to third-party networks and protocols to route communication based on the profile information and routing instructions, and the devices that run our client software or are able to receive communication from our system via a third-party network or protocol.

The user initiation process occurs as follows. The user first registers for an account and enters in profile data, which is subsequently stored on the server as profile information associated with the user's identity. The user then creates privacy settings that are applied to the profile information specifying who is allowed to view the information. Finally, the user enters their account information for the third-party networks that they wish to unify through our service, including email accounts, instant messaging accounts, their wireless phone provider and phone number, any other relevant phone numbers, and any other relevant information for other third-party services that our system may support.

The user can then log in to our system to view and search all messages and communication, sent both internally and via third party accounts depending upon our system's level of access to those third-party accounts. Our system can view and receive messages from these third-party accounts via associated Application Programming Interfaces or via specialized gateways and proxy servers associated with that particular type of protocol.

When logged in, the user can import contacts from a third-party client application or service or can create a contact list from scratch. If a contact the user wishes to add is already a user on our system, the system already recognizes their contact information and no more information is necessary. If the contact is not already a user on our system, their individual device and contact information must be entered manually. If that contact does eventually become a user, the system will recognize that and update the contact list accordingly. The contacts can further be broken down into categories and subcategories for viewing ease and routing purposes. The contact list automatically checks the status of each user and returns the status of that contact viewable to the user whose contact list they appear on based on privacy and other related settings. Users can view detailed profile information and search for contacts based on each individual user's privacy preferences for who can view their profile information.

The user can then initiate communication to a contact or non-contact. Real-time text or voice communication can be initiated if the contact is online and/or specifies that they can be contacted for real-time communication by that user. Static text and voice messages can always be sent to any contact and will be stored and routed via email, SMS, IM, other text format, or as a voice message according to that contact's settings.

Users can specify routing settings based on multiple variables, including sender identity, calendar information entered manually or imported from a third-party client application or service, location via GPS data if applicable, urgency, or any other variable that may be relevant to communication routing preferences.

When a user of our system is not logged in, their status and profile information is still viewable to other contacts depending upon pre-specified privacy settings. Messages received by our system on behalf of a user are routed via third-party networks and protocol's to as many of the user's individual devices as they wish depending upon their pre-specified routing settings.

The user can access and edit all of the information on their account, including contact list, routing preferences, calendar, archived messages, and certain message initiation features from any Internet-connected device via our client software or web interface. The user can also access and edit all of this information via a voice-prompt interface through traditional phone lines. The user may be able to access all of this functionality from third-party client applications or services for which we have developed a software plug-in or through which we have a service partnership.

As to a further discussion of the manner of usage and operation of the present invention, the same should be apparent from the above description. Accordingly, no further discussion relating to the manner of usage and operation will be provided.

With respect to the above description then, it is to be realized that the optimum programmatic relationships for the components of the invention, to include variations in protocols, networks, form, function and manner of operation, integration and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1) A method of unifying IP-based text and voice communication into a centralized network comprised of servers and multiple client interfaces, whereby multiple types of data from multiple third-party communication networks are stored on the servers; all of this data can be viewed from individual client interfaces; all of the data can be dynamically routed to individual client interfaces; further, all of this data can be initiated from client interfaces and relayed to recipients on the same network or third-party networks.

2) The method of claim 1, further comprising IP-based text and voice data consisting of email, instant messages, Short Message Service (SMS) messages, Multimedia Message Service (MMS) messages, Voice-over-IP (VoIP) transmissions, voicemail, faxes, and pager messages.

3) The method of claim 1, further comprising servers running software that connects to third-party networks for transmittal of said IP-based text and voice communication over the necessary protocols including email networks, instant messaging networks, cell phone networks, Public Switched Telephone Networks (PSTN), and similar instances of third-party networks to relay communication to the desired recipients; receiving communication from said third-party networks; storing said IP-based text and voice communication into a unified database or similar method of data storage; dynamically relaying incoming IP-based text and voice communication to client interface; sending and receiving said types of communication within the same network in addition to outside the network as described above.

4) The method of claim 1, further comprising a dynamic server-based routing algorithm for relaying messages to specific client devices based on user availability and preferences.

5) The method of claim 1, further comprising client software that receives dynamically routed messages in text and/or voice form.

6) The method of claim 1, further comprising client software that access and enables viewing of centrally stored messages from the server-side database and interacts with the application server to send new messages of multiple data types.

7) The method of claim 1, further comprising client software that runs on multiple types of devices, including but not limited to personal computers, personal digital assistants, and cellular phones.

8) The method of claim 1, further comprising the storage of user profiles with real-time presence information on the server-side database, whose accessibility by other users is governed by user preferences

9) The method of claim 8, further comprising the linking of other user profiles to one another in the form of contact lists on the server-side database, such that any form of the client software on any device can access the same said contact list; data changed on a user profile will change on all other contact lists linking to that profile; recipient addresses of messages sent to contacts on the contact list will automatically update based on the contact's most recent profile information.

10) The method of claim 1, further comprising a set of user preferences governing the specific logic for routing incoming messages via the server-side software to individual client devices, the accessibility of user profile information to other users, and the specific third-party accounts and networks to which the user's account will link.
